(19) United States
(12) Patent Application Publication
(10) Pub. No.: US 2026/0097836 A1
(43) Pub. Date: Apr. 9, 2026

(54) NOVEL SYSTEMS AND METHODS FOR LAUNCHING HIGH-ALTITUDE BALLOONS

(71) Applicants: Sarah Ann Schubert, Berkeley, CA (US); Daniel Patrick Bowen, Oakland, CA (US); Alexander Sullivan Wong, South Pasadena, CA (US)

(72) Inventors: Sarah Ann Schubert, Berkeley, CA (US); Daniel Patrick Bowen, Oakland, CA (US); Alexander Sullivan Wong, South Pasadena, CA (US)

(21) Appl. No.: 19/353,635

(22) Filed: Oct. 9, 2025

Related U.S. Application Data
(60) Provisional application No. 63/705,386, filed on Oct. 9, 2024.

(51) Int. Cl. B64B 1/00; B64B 1/58

(52) U.S. Cl. CPC B64B 1/005; B64B 1/58

(57) ABSTRACT

Balloon launching systems and methods relating thereto are described. A method of launching a balloon includes securing a balloon to an everting platform and disposing the platform within a launch chamber having an inflatable tubular membrane. The everting platform couples to the inflatable tubular membrane such that the balloon is positioned inside a launch cavity while a pressurization cavity is defined adjacent thereto. Lifting gas is dispensed into and sealed within the balloon. The pressurization cavity is pressurized to an everting pressure causing the inflatable tubular membrane to evert and extend above a balloon launching end of the launch chamber. The everting membrane accelerates the inflated balloon toward the launching end and surrounds and shields the balloon from cross-winds and ground obstacles. The balloon is released after membrane extension.

### RELATED APPLICATION

This application claims priority to provisional application No. 63/705,386, filed on Oct. 9, 2024, which is incorporated herein by reference for all purposes.

### FIELD

The present arrangements and teachings relate generally to novel systems and methods for launching high-altitude balloons (hereinafter also referred to as a “balloon”). More particularly, the present arrangements and teachings relate to novel systems and methods for launching high-altitude balloons using controlled mechanical propulsion through an everting tubular membrane.

### BACKGROUND

Due to the fragile properties of materials used to make high-altitude balloons, launching the high-altitude balloon in a conventional manner poses significant risk of damage to the high-altitude balloon. Moreover, launching is limited to ambient weather conditions because damage is likely due to wind shear, manual handling of the high-altitude balloons during and after lifting gas fill, and rupture due to contact with objects in proximity to the launch zone.

What is needed, therefore, are systems and methods for launching high-altitude balloons that protect the high-altitude balloons during lifting gas fill and launch.

### SUMMARY

To achieve the foregoing, the present teachings provide novel systems and methods for launching high-altitude balloons. In one aspect, the present arrangements provide novel balloon eversion launching systems. An exemplar of such balloon eversion launching systems includes: (i) a launch chamber; (ii); an everting platform; (iii) an inflatable tubular membrane; and an actuation gas supply subsystem.

The launch chamber that includes sidewalls, a balloon securing end, and a balloon launching end and has defined therein an opening capable of receiving an actuation gas that contributes to the launch of a balloon.

The everting platform is disposed inside the launch chamber in a non-everted state, disposed inside and/or outside the launch chamber in a partially everted state, and disposed outside the launch chamber in a substantially everted state.

The inflatable tubular membrane is coupled and arranged contiguous with the everting platform and is disposed inside the launch chamber, extending from the balloon launching end to the balloon securing end. The presence of the inflatable tubular membrane and the everting platform inside the launch chamber divides a space inside the launch chamber and defines a pressurization cavity and a launch cavity. The pressurization cavity is defined by the sidewalls, the balloon securing end, the everting platform, and the inflatable tubular membrane. The launch cavity is defined by the inflatable tubular membrane, the everting platform, and the balloon launching end, and is configured to receive and position the balloon for launch.

The actuation gas supply subsystem supplies the actuation gas to the pressurization cavity. In the non-everted state of the everting platform, the pressurization cavity is occupied with no or an insufficient amount of the actuation gas to cause eversion of the inflatable tubular membrane and produce a non-everted membrane, which is not capable of ejecting the balloon.

In one embodiment of the present arrangements, the insufficient amount of the actuation gas does not produce any eversion of the inflatable tubular membrane and no portion of the inflatable tubular membrane is disposed outside of the balloon launching end.

In the partially everted state of the everting platform, the pressurization cavity is filled with a sufficient amount of the actuation gas to cause a portion of the inflatable tubular membrane to extend outside the balloon launching end such that the inflatable tubular membrane is configured to fully shield the balloon prior to ejection. In one embodiment of the present arrangements, the extending portion of the inflatable tubular membrane is configured to fully shield the ballon prior to ejection.

In another embodiment of the present arrangements, the sufficient amount of the actuation gas, in the partially everted state, causes a non-extending portion of the inflatable tubular membrane to remain inside the launch chamber such that the non-extending portion of the inflatable tubular membrane and/or the extending portion of the inflatable tubular membrane is configured to fully shield the ballon prior to ejection.

In yet another embodiment of the present arrangements, the sufficient amount of the actuation gas is configured to cause the inflatable tubular membrane to cover between about 90% and about 100% of surface area of the balloon in the partially everted state.

In the substantially everted state of the everting platform, the pressurization cavity is filled with an enhanced amount of the actuation gas to cause a substantial portion of the inflatable tubular membrane to extend outside the balloon launching end, wherein the inflatable tubular membrane is configured to at least partially shield and ultimately eject the balloon. In one embodiment of the present arrangements, the substantial portion of the inflatable tubular membrane is configured to fully shield the ballon prior to ejection.

In another embodiment of the present arrangements, the enhanced amount of the actuation gas, in the substantially everted state, causes a reduced non-extending portion of the inflatable tubular membrane to remain inside the launch chamber such that the reduced the non-extending portion of the inflatable tubular membrane and/or the substantial portion of the inflatable tubular membrane is configured to partially shield and ultimately eject the balloon.

In yet another embodiment of the present arrangements, the enhanced amount of the actuation gas is configured to cause the inflatable tubular membrane to cover between about 1% and about 89% of surface area of the balloon in the substantially everted state.

In one embodiment of the present arrangements, the launch chamber is cylindrical, and the coupled inflatable tubular membrane is secured to a perimeter that defines a circumference of the balloon launching end. In another embodiment, the balloon securing end includes a balloon insertion port configured to allow insertion of the everting platform and balloon into the launch chamber.

In yet another embodiment of the present arrangements, the inflatable tubular membrane includes a securing ring that has defined therethrough a securing ring aperture configured to receive the balloon, and one or more coupling mechanisms for coupling the securing ring to the everting platform and to prevent transfer of the gas from the pressurization cavity to the launch cavity.

In a further embodiment of the present arrangements, the launch chamber includes an exhaust port to exhaust gas from the pressurization cavity.

In another embodiment of the present arrangements, a retracting mechanism is coupled to the everting platform and the balloon securing end, wherein the retracting mechanism retracts the everting platform towards the balloon securing end when the everting platform is pushed towards and/or outside the balloon launching end and controls an upward rate of eversion acceleration of the everting platform.

In one embodiment of the present arrangements, the balloon launching end is proximate to a roofline. In another embodiment, the system further comprises a movable weather cover that covers or is retracted over the balloon launching end.

In yet another embodiment of the present arrangements, the everting platform includes a balloon fastener designed to fasten and release the balloon from the everting platform.

In a further embodiment, the inflatable tubular membrane is made of at least one material selected from a group including nylon, polyester, polyolefin, fluoropolymer, thermoplastic elastomer, silicone elastomer, polycarbonate, polyetherimide, polyphenylene sulfide, polyether-ether-ketone, ethylene-vinyl acetate, and polyvinyl chloride.

In another aspect, the present teachings provide methods of launching a balloon. An exemplar method of launching a balloon includes securing, using a balloon fastener, the balloon to an everting platform.

Another element includes disposing the everting platform with the balloon secured thereto within a launch chamber having an inflatable tubular membrane disposed therein, Yet another element includes coupling the everting platform to the inflatable tubular membrane such that the balloon is positioned inside a launch cavity disposed within the launch chamber.

The method further includes dispensing a predetermined volume of lifting gas into the balloon and sealing, using a sealing mechanism, the balloon to seal the predetermined volume of lifting gas in the balloon to produce an inflated balloon. A pressurization cavity of the launch chamber is then pressurized to an everting pressure, the pressurization cavity being disposed adjacent to the launch cavity, wherein the everting pressure causes at least a portion of the inflatable tubular membrane to evert and extend above a balloon launching end of the launch chamber to produce an everting tubular membrane.

The method includes accelerating, using the everting tubular membrane, the inflated balloon and the everting platform toward the balloon launching end, and

Contemporaneously and after the accelerating element a shielding element is carried out which includes shielding, using the everting tubular membrane, the inflated balloon from cross-winds and ground obstacles, wherein at least a portion of the everting tubular membrane surrounds the inflated balloon.

The inflated balloon is then released, using the balloon fastener, from the everting platform after the inflatable tubular membrane has extended above the balloon launching end.

In one embodiment of the present teachings, the method further includes pre-pressurizing the pressurization cavity to an initial containment pressure before dispensing the lifting gas, wherein at least a portion of the inflatable tubular membrane is proximate to and/or contacting the balloon resulting from the initial containment pressure, and wherein the initial containment pressure is less than the everting pressure.

In another embodiment of the present teachings, releasing the inflated balloon includes releasing the inflated balloon from the everting platform at a predetermined distance above the balloon launching end or at a predefined pressure within the pressurization cavity.

In yet another embodiment of the present teachings, the method further comprises controlling, using a retracting mechanism, the vertical acceleration of the inflated balloon, wherein the retracting mechanism is coupled to the everting platform and the launch chamber.

In a further embodiment of the present teachings, the method further comprises venting gas from the pressurization cavity and retracting, using the retracting mechanism, the everting platform towards an initial position within the launch chamber.

In another embodiment of the present teachings, coupling the everting platform to the inflatable tubular membrane includes securing the everting platform to a securing ring, wherein the securing ring is coupled to the inflatable tubular membrane.

In yet another embodiment of the present teachings, the everting pressure is a pressure that ranges from between about 100 pascals and about 5 kilopascals.

In a further embodiment of the present teachings, accelerating the inflated balloon toward the balloon launching end occurs at an acceleration rate that ranges from between about 0.1 meters per second squared and about 10 meters per second squared.

In another embodiment of the present teachings, the inflated balloon moves toward the balloon launching end at a maximum velocity that ranges from between about 0.5 meters per second and about 15 meters per second.

The construction and method of operation of the invention, however, together with additional objects and advantages thereof, will be best understood from the following descriptions of specific embodiments when read in connection with the accompanying figures.

### BRIEF DESCRIPTION

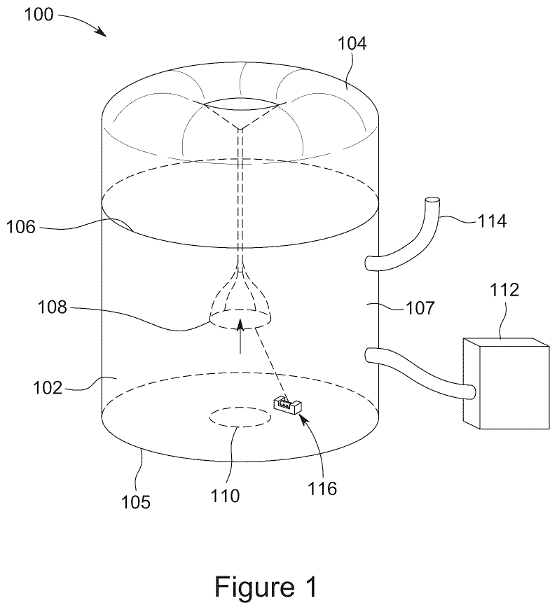

FIG. 1 shows a balloon eversion launching system, according to one embodiment of the present arrangements, that includes a inflatable tubular membrane and an everting platform disposed within a launch chamber.

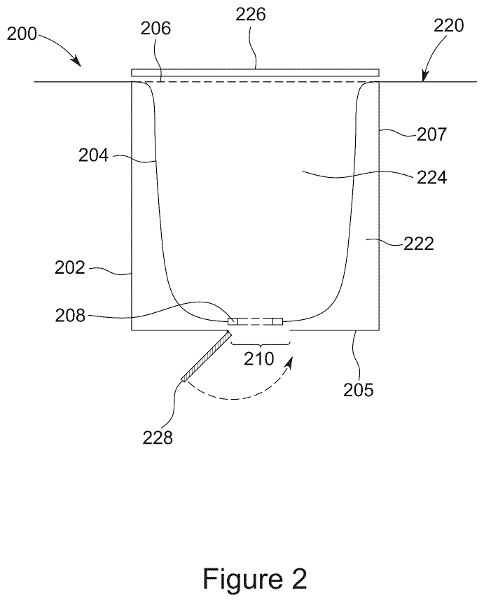

FIG. 2 shows a cross-sectional view of the balloon eversion launching system, according to another embodiment of the arrangements, which includes a pressurization cavity and a launch cavity.

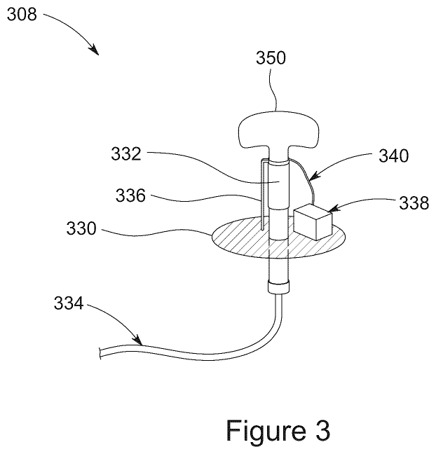

FIG. 3 shows a perspective view of an everting platform, according to one embodiment of the present arrangements, that is used to secure, inflate, and launch the balloon.

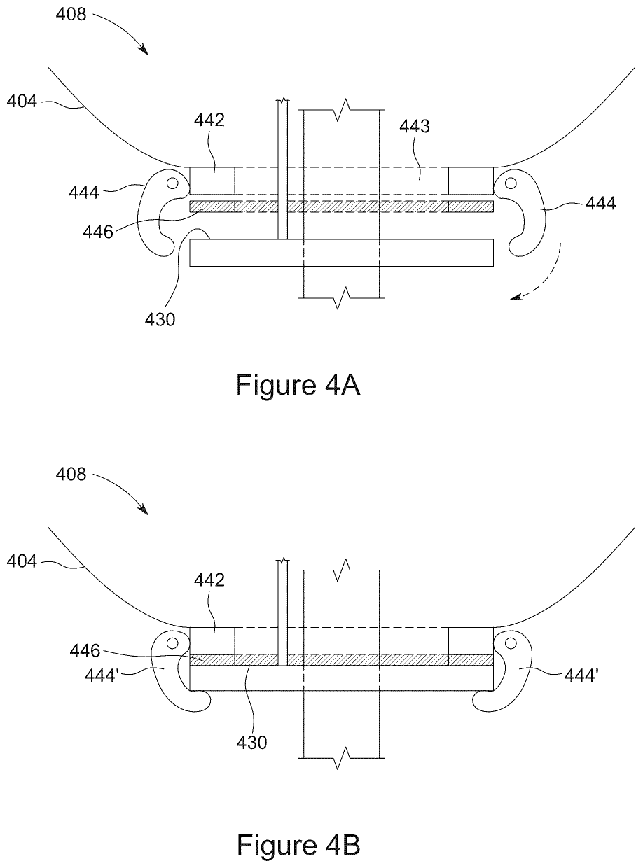

FIG. 4A shows an everting platform, according to another embodiment of the present arrangements, in an uncoupled state positioned proximate to a securing ring for securing the everting platform to the inflatable tubular membrane.

FIG. 4B shows the everting platform of FIG. 4A in a coupled state, wherein the everting platform is latched to the securing ring.

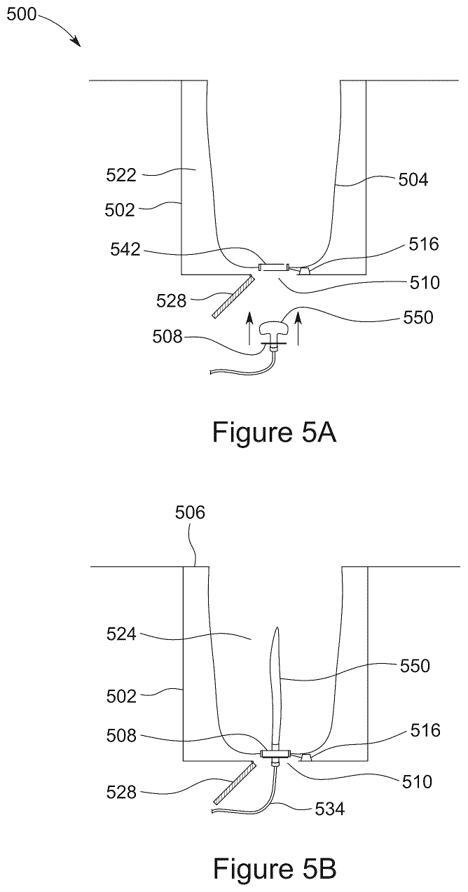

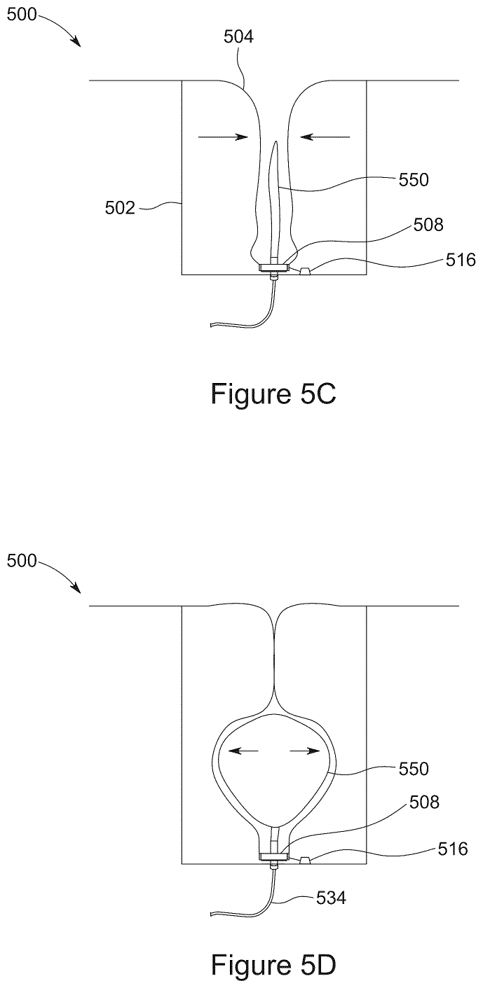

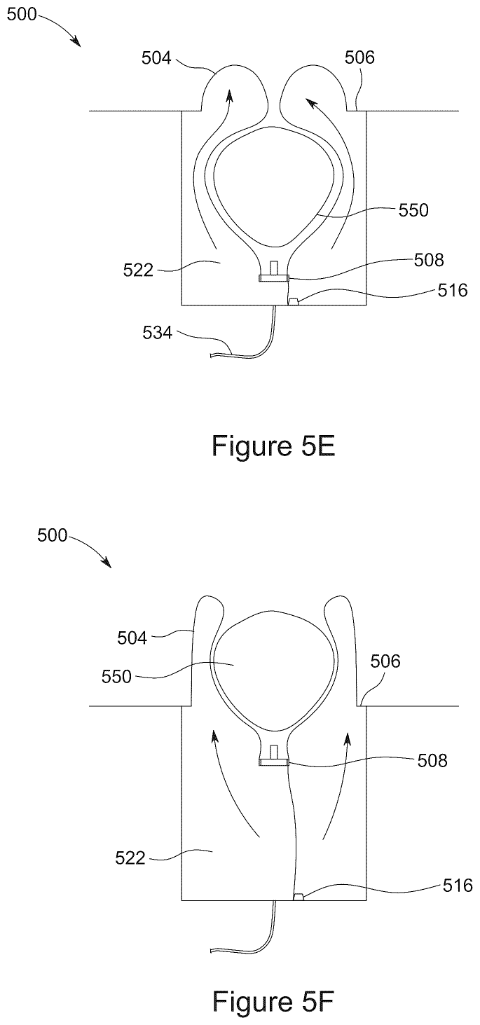

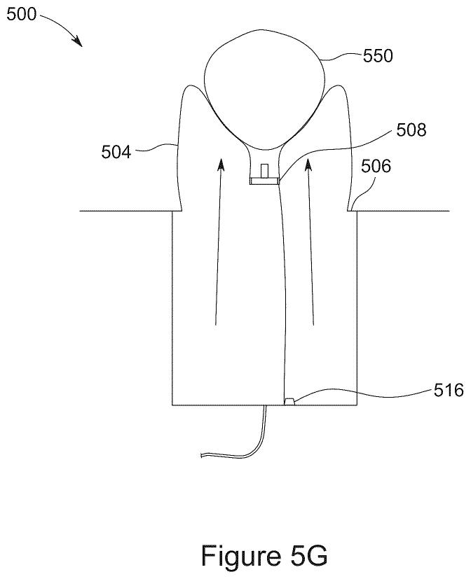

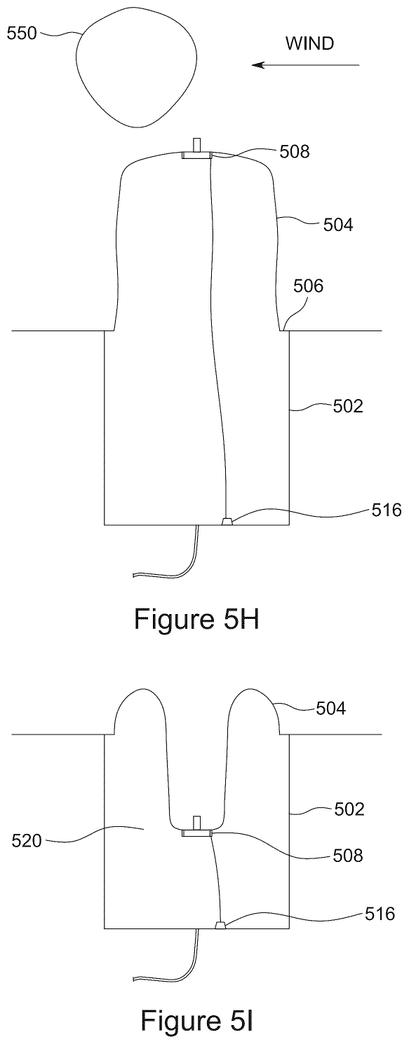

FIG. 5A shows an operative state of a balloon eversion launching system, according to one embodiment of the present arrangements, in which the everting platform and deflated balloon are below the launch chamber.

FIG. 5B shows another operative state of the balloon eversion launching system of FIG. 5A, according to one embodiment of the present arrangements, with an everting platform being coupled to the inflatable tubular membrane and a balloon positioned within a launch cavity.

FIG. 5C shows an optional operative state of the balloon eversion launching system of FIG. 5A, according to one embodiment of the present arrangements, in which a pressurization cavity is pre-pressurized.

FIG. 5D shows another operative state of the balloon eversion launching system of FIG. 5A, according to one embodiment of the present arrangements, in which the balloon is inflated with a lifting gas.

FIG. 5E shows another operative state of the balloon eversion launching system of FIG. 5A, according to one embodiment of the present arrangements, in which gas is disposed within the pressurization cavity and the inflatable tubular membrane begins to evert above a balloon launching end of the launch chamber.

FIG. 5F shows another operative state of the balloon eversion launching system of FIG. 5A, according to one embodiment of the present arrangements, during active eversion with the inflatable tubular membrane lifting the balloon and everting platform upward.

FIG. 5G shows another operative state of the balloon eversion launching system of FIG. 5A, according to one embodiment of the present arrangements, in an advanced eversion state with the balloon beginning to emerge from the inflatable tubular membrane.

FIG. 5H shows another operative state of the balloon eversion launching system of FIG. 5A, in which the inflatable tubular membrane is at maximum eversion and the balloon is ascending as a free-flying balloon.

FIG. 5I shows another operative state of the balloon eversion launching system of FIG. 5A, in which the everting platform is retracted, thereby inverting the inflatable tubular membrane.

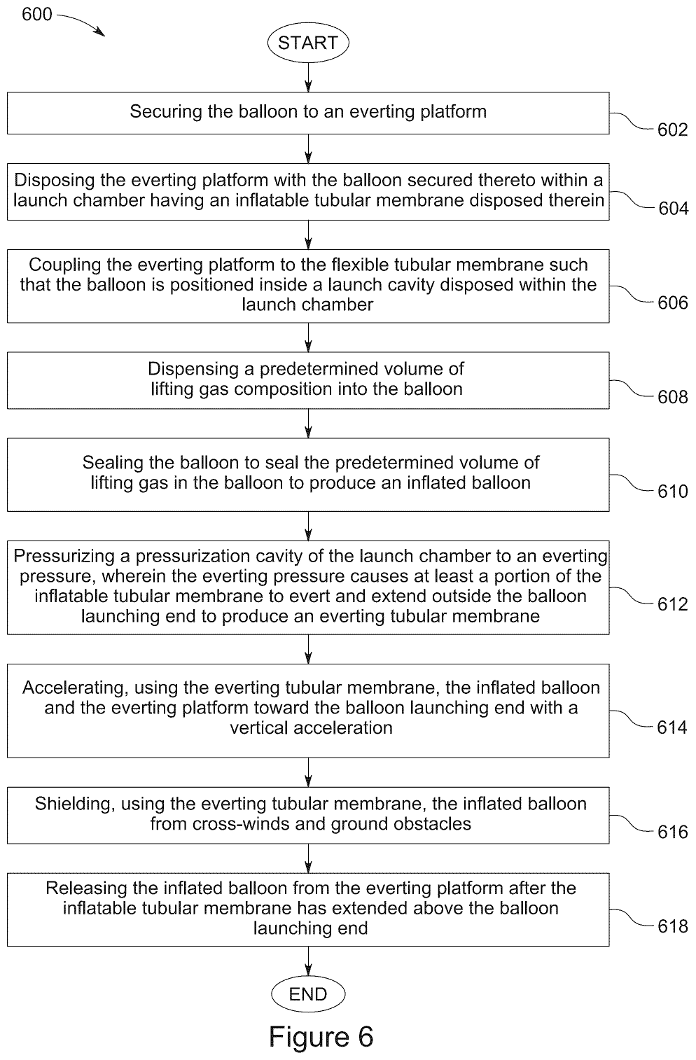

FIG. 6 is a flowchart illustrating a method of launching a balloon according to one embodiment of the present arrangements.

### DETAILED DESCRIPTION

In the following description, numerous specific details are set forth in order to provide a thorough understanding of the present invention. It will be apparent, however, to one skilled in the art that the present invention may be practiced without limitation to some or all of these specific details. In other instances, well known process elements have not been described in detail in order to not unnecessarily obscure the invention.

The deployment of a balloon is frequently constrained by limitations inherent in conventional launching systems and methods. Conventional methods, which often rely on significant manual handling of the fragile balloon envelope during and after gas fill, are highly susceptible to envelope damage, premature bursts, and are limited by ambient weather conditions. Specifically, high surface wind speeds and wind shear significantly reduce the operational launch window, and ground-based obstacles, such as antennae, launch hardware, or uneven terrain, pose a significant risk of collision as the balloon assembly begins its slow, buoyancy-driven ascent.

The present arrangements and teachings overcome these inadequacies by introducing novel systems and methods for controlled mechanical propulsion. By utilizing an inflatable tubular membrane that is pressurized to evert rapidly, the system eliminates hazardous manual handling, actively provides a deployable wind shield that guides the envelope clear of obstacles, and imparts a vertical acceleration to the balloon and payload assembly that is demonstrably greater than the balloon's natural acceleration. This controlled, high-speed propulsion expands the operational envelope, enabling safe launches in environments previously deemed unsuitable due to high wind speeds or cluttered launch areas.

FIG. 1 shows a balloon eversion launching system 100 according to one embodiment of the present arrangements, which includes a launch chamber 102 and an inflatable tubular membrane 104. Launch chamber 102 includes a balloon securing end 105, disposed at a lower portion of the chamber, and a balloon launching end 106, disposed at an upper portion of the chamber. Sidewalls 107 extending between balloon securing end 105 and balloon launching end define a launch chamber cavity. A balloon insertion port 110 is positioned on balloon securing end 105, providing access to the launch chamber cavity.

Balloon securing end 105 and sidewalls 107 define a rigid enclosure. Inflatable tubular membrane 104 is coupled with balloon launching end 106 of the launch chamber 102 and disposed inside launch chamber 102. An everting platform 108 is coupled to and contiguously arranged with inflatable tubular membrane 104.

In the embodiment shown in FIG. 1, balloon securing end 105 and sidewalls 107 define a rigid cylindrical enclosure. A first end of the inflatable tubular membrane 104 is coupled to the launch chamber 102 at a circumferential edge where the balloon launching end 106 meets the sidewalls 107.

An actuation gas supply system 112 is coupled to the launch chamber 102 via supply conduits to deliver actuation gas into the pressurization cavity. A gas exhaust port 114 is provided in sidewalls 107 for venting gas from launch chamber 102, for example, pressurization cavity 222 of FIG. 2. In one embodiment of the present arrangements, gas dispensed from gas exhaust port 114 is transmitted to actuation gas supply system 112 to be used again for another pressurization event.

A retracting mechanism 116, disposed within the launch chamber 102, is operatively coupled between everting platform 108 and the balloon securing end 105 of the launch chamber 102. Retracting mechanism 116 controls the upward acceleration of everting platform 108 and subsequent retraction following a balloon launch. In one embodiment of the present arrangements, retracting mechanism 116 also functions to keep the everting platform centered along the center axis of launch chamber 102 during both the eversion and retraction of inflatable tubular membrane 104. In this embodiment, two or more retracting mechanisms 116 are arranged radially and connect the everting platform 108 to the retraction mechanism. Retracting mechanism 116 provide lateral tension to control a tilt angle of tubular flexible membrane 104 and/or everting platform 108 as they evert and retract. Moreover, retracting mechanism 116 inhibits lateral movement of tubular flexible membrane 104 and/or everting platform 108.

FIG. 2 shows a balloon eversion launching system 200 according to one embodiment of the present arrangements, which is substantially similar to balloon eversion launching system 100 of FIG. 1. Balloon eversion launching system 200 includes an inflatable tubular membrane 204, balloon securing end 205, balloon launching end 206, sidewalls 207, everting platform 208, and balloon insertion port 210 that are substantially similar to inflatable tubular membrane 104, balloon securing end 105, balloon launching end 106, sidewalls 107, everting platform 108, and balloon insertion port 110 of FIG. 1, respectively.

Inflatable tubular membrane 204, balloon securing end 205, and sidewalls 207 define a pressurization cavity 222 that receives gas from an actuation gas supply system (e.g., actuation gas supply system 112 of FIG. 1). Inflatable tubular membrane 204 and balloon launching end 206 define a launch cavity 224 that will house a balloon during at least a portion of launching operations.

The balloon launching end 206, of launch chamber 202, may be substantially parallel with or below roofline 220. A weather cover 226 covers balloon launching end 206 but may be removed during launch of the balloon. A door 228 covers and/or seals balloon insertion port 210. During a loading phase, the door 228 opens to permit vertical insertion of the balloon, payload, and/or everting platform 208 from outside launch chamber 202, through the balloon insertion port 210, and upward into launch cavity 224. Once everting platform 208 is properly positioned and coupled to the second end of the inflatable tubular membrane 204, the door 228 closes and seals against balloon securing end 205 to create a pressure-tight enclosure. This sealing function enables pressurization cavity 222 to be pressurized with actuation gas without leakage. The door 228 may be a hinged, sliding, or clamshell design and includes pressure-rated seals to maintain the integrity of the pressurization cavity during launch operations.

The teachings recognize that inflatable tubular membrane 204 may be made of various materials. The selection of material for inflatable tubular membrane 204 is informed by physical and/or chemical properties such as resistance to tearing, puncture, and fatigue during repeated eversion cycles, while minimizing frictional or abrasive contact with the balloon envelope. For example, the material preferably combines high tensile strength and tear resistance with low surface friction and controlled elasticity, thereby reducing balloon damage during inflation and launch, and maintaining geometric stability against wind loads and transient pressure differentials.

Inflatable tubular membrane 204 may be manufactured for example using polyamides (including nylon 6, nylon 6,6, nylon 6,12, nylon 11, nylon 12), polyesters (including PET, PBT, and PEN), polyolefins (including LDPE, LLDPE, HDPE, polypropylene, and ultra-high-molecular-weight polyethylene (UHMWPE)), liquid-crystal polymer fibers (e.g., Vectran®), aramids (including para-aramid, e.g., Kevlar®, Twaron®, Technora®, and meta-aramid, e.g., Nomex®), poly(p-phenylene-2,6-benzobisoxazole, e.g., PBO/Zylon®), fluoropolymers (including PTFE, ePTFE, FEP, PFA, ETFE, PVDF, ECTFE, PVF/Tedlar®), thermoplastic elastomers (including TPU, TPC-ET/copolyester elastomer, e.g., Hytrel®, PEBA/Pebax®, TPO, SEBS/SBS), silicone elastomers (PDMS), ionomers (e.g., Surlyn®), polycarbonate (PC) film, polyimide (e.g., PI/Kapton®) film, polyetherimide (PEI), polyphenylene sulfide (PPS), polyether-ether-ketone (PEEK), ethylene-vinyl acetate (EVA), polyvinyl chloride (PVC), chlorosulfonated polyethylene (CSM), chloroprene rubber (CR/neoprene), nitrile rubber (NBR) and NBR/PVC blends, and laminates, coated fabrics, scrim-reinforced films, and composites thereof.

Inflatable tubular membrane 204 may include woven, nonwoven, knitted, or film constructions and/or be coated or laminated with thermoplastics or elastomers including TPU-coated nylon or polyester, silicone-coated nylon, PTFE-coated glass or aramid fabric, PVF (Tedlar®)- or PVDF-laminated fabric, UHMWPE fiber-reinforced films (Dyneema® Composite Fabric/Cuben Fiber), aramid-scrim-reinforced films, and co-extruded barrier films (e.g., PET/EVOH/PE, PET/PVDC/PE). Optional surface finishes include fluoropolymer slip coats (e.g., FEP/PFA/PVDF), silicone release finishes, anti-static finishes (e.g., conductive scrim or coating), abrasion-resistant polyurethane topcoats, and UV-stabilized coatings. The selection of material and construction may vary with balloon size, pressure requirements, and operational environment as depicted in FIG. 1-5.

In one embodiment of the present arrangements, an outer surface of inflatable tubular membrane 204 resists scuffing or flutter under cross-wind exposure, while also providing a smooth, low-adhesion interface with the balloon. Additionally, in a preferred embodiment of the present arrangements, an additional protective layer of material is added between inflatable tubular membrane 204 and the balloon to protect the balloon from tearing or abrasion caused by movement or wrinkling of inflatable tubular membrane 204 and from contact with sharp corners created by folding or wrinkling of inflatable tubular membrane 204. The protective layer may include materials with very high slip, low bending stiffness and/or stretchy and nonconforming material, including but limited to polytetrafluoroethylene (PTFE) film, fluorinated ethylene propylene (FEP) film, Perfluoroalkoxy PFA film, nylon, spandex, tricot, TPU film, TPU-coated knit, microfiber knit, or velour knits.

In one embodiment of the present arrangements, inflatable tubular membrane 204 has material thickness that ranges from between about 25 micrometers and about 2000 micrometers. In a preferred embodiment of the present arrangements, inflatable tubular membrane 204 has a material thickness that ranges from between about 75 micrometers and about 500 micrometers. In a more preferred embodiment of the present arrangements, inflatable tubular membrane 204 has a material thickness that ranges from between about 90 micrometers and about 150 micrometers.

In one embodiment of the present arrangements, launch chamber 202 has an internal diameter that ranges from between about 1 meter and about 20 meters. In a preferred embodiment of the present arrangements, launch chamber 202 has an internal diameter that ranges from between about 2 meters and about 15 meters. In more preferred embodiment of the present arrangements, launch chamber 202 has an internal diameter that ranges from between about 3 meters and about 5 meters.

FIG. 3 shows an everting platform 308, according to one embodiment of the present arrangements, that includes sealing plate 330, a gas diffuser 332, and a balloon fastener 336.

Discussed in greater detail below, sealing plate 330 seals against the inflatable tubular membrane (e.g., securing ring 442 of FIG. 4) to prevent transfer of gas from the pressurization cavity to the launch cavity. Gas diffuser 332 extends upward from the sealing plate 330 and dispenses a lifting gas into a balloon envelope during balloon inflation. Gas diffuser 332, in one embodiment of the present arrangements, includes an inflation nozzle that interfaces with the neck of the balloon and retracts after the balloon reaches target fill volume. Balloon fastener 336 is disposed on or adjacent to the sealing plate 330 to secure the balloon 350 to the everting platform 308 during inflation and eversion, and to release balloon 350 at a predetermined point during the launch sequence. A lifting gas supply line 334 is shown coupled to an underside of the everting platform 308, providing fluid communication between a lifting gas reservoir and the gas diffuser 332.

Everting platform 308, in one implementation of the present arrangements, includes a payload mounting location 338 that supports a payload that is attached to the balloon via a tether 340. Tether 340 may be any component that couples the payload to the balloon, e.g., string, rope, or wire.

FIGS. 4A and 4B show an everting platform 408, according to another embodiment of the present arrangements, that is coupled to an inflatable tubular membrane 404. The second end of inflatable tubular membrane 404 includes a securing ring 442 that is coupled to (e.g., bonded) to the inflatable tubular membrane 404 and provides structural support for coupling with everting platform 408. The securing ring 442 has disposed therethrough a securing ring aperture 443 to allow passage of a balloon and at least a portion of everting platform 408 during insertion into the launch cavity (e.g., launch cavity 224 of FIG. 2).

FIG. 4A shows everting platform 408 in an uncoupled state, positioned below securing ring 442. The everting platform 408 includes a sealing surface 430 configured to interface with and seal against the securing ring 442. A sealing member 446 is disposed between sealing surface 430 and securing ring 442. One or more coupling mechanisms 444 are disposed on the securing ring 442 and/or the everting platform 408 to enable mechanical coupling between the two components.

FIG. 4B shows the everting platform 408 in a coupled state, wherein the everting platform 408 is latched to securing ring 442 via one or more coupling mechanisms 444. In the coupled state, sealing surface 430 closes securing ring aperture 443, and sealing member 446 forms a pressure-tight seal that prevents transfer of actuation gas from the pressurization cavity to the launch cavity. One or more coupling mechanisms 444′ may comprise latches, clamps, or other fastening devices configured to maintain the seal during pressurization and eversion of the inflatable tubular membrane 404.

FIGS. 5A through 5I show a balloon eversion launching system 500, according to one embodiment of the present arrangements in various operative states, illustrating various launch elements.

FIG. 5A shows balloon eversion launching system 500 in a non-everted state, according to one embodiment of the present arrangements. An inflatable tubular membrane 504 is fully retracted within a launch chamber 502, with a pressurization cavity 522 in an unpressurized state. A securing ring 542 is coupled, at a second end, to inflatable tubular membrane 504. A weather cover (e.g., weather cover 226 of FIG. 2) may be deployed over a balloon launching end 506, protecting the launch chamber 502 from environmental conditions. An everting platform 508 is positioned below launch chamber 502 with a balloon 550 in a folded or uninflated state attached to a gas diffuser on everting platform 508. A payload may be attached to balloon 550 via a tether. A door 528 at a balloon securing end is in an open position to create a balloon insertion port 510, allowing access to the launch chamber 502. In one embodiment of the present arrangements, the balloon may be attached to the everting platform above the launch chamber. In this embodiment, balloon 550 and launch platform 508 enter launch chamber 502 from the launching end and are then installed on the balloon securing end. In this embodiment, the balloon securing end may or may not be in an open position.

FIG. 5B shows balloon eversion launching system 500 in the non-everted state, according to another embodiment of the present arrangements. Everting platform 508 has been lifted vertically through the balloon insertion port 510 and is being coupled or latched to the securing ring at the second end of inflatable tubular membrane 504. Balloon 550 is now positioned within a launch cavity 524 defined by the inflatable tubular membrane 504 and balloon launching end 506. Door 528 is shown closing to seal the balloon insertion port at balloon securing end 505. Lifting gas supply line 534 remains coupled to everting platform 508 when door 528 is shut and sealed. A pass-through port may be provided in door 528 to maintain a pressure-tight seal around lifting gas supply line 534 when door 528 is shut and sealed. In one embodiment of the present arrangements, this pass-through port includes a radial slot in the door, encompassing flexible split seal flaps, which envelops the lift gas supply line as the door closes to maintain a pressure-tight seal around the lifting gas supply line 534 when door 528 is shut and sealed.

FIG. 5C shows balloon eversion launching system 500 in the non-everted state, according to yet another embodiment of the present arrangements. The balloon insertion port is fully sealed, creating a pressure-tight enclosure at balloon securing end 505. Pressurization cavity 522 is pre-pressurized with actuation gas, causing inflatable tubular membrane 504 to expand into, reduce the volume of launch cavity 524, and surround the uninflated balloon 550 to provide a protective barrier around balloon 550 and prevent it from prematurely exiting the launch chamber when filled with lift gas. However, the pressurization cavity is occupied with an insufficient amount of the actuation gas to cause eversion of the inflatable tubular membrane. A non-everted inflatable tubular membrane is not capable of ejecting the balloon. In one aspect, the actuation gas supply system regulates and may recycle gas to minimize gas loss between successive launch cycles.

FIG. 5D shows balloon eversion launching system 500 in the non-everted state, according to yet another embodiment of the present arrangements. Balloon 550 is inflated with a lifting gas dispensed through the gas diffuser on everting platform 508. If the optional pre-pressurization of the pressurization cavity is carried out, as balloon 550 expands, at least a portion of inflatable tubular membrane 504 conforms to the expanding balloon envelope surface, maintaining at least partial contact with and shielding balloon 550. Pressurization cavity 522 remains pre-pressurized to maintain the expanded configuration of inflatable tubular membrane 504.

FIG. 5E shows balloon eversion launching system 500 in a partially everted state, according to one embodiment of the present arrangements, where the pressurization cavity is pressurized to an everting pressure. The everting pressure is a sufficient amount of the actuation gas to cause at least a portion of inflatable tubular membrane 504 to evert and extend above or outside the balloon launching end 506 to produce an everted tubular membrane.

In the partially everted state, the non-everted membrane (i.e., inflatable flexible membrane that remains inside the launch chamber), in one embodiment of the present arrangements, fully shield the balloon from transverse and/or shear winds prior to ejection. In another embodiment of the present arrangements, the non-everted membrane and the everted tubular membrane fully shield the balloon from transverse and/or shear winds prior to ejection. In yet another embodiment of the present arrangements, the everted tubular membrane fully shield the balloon from transverse and/or shear winds prior to ejection. To fully shield the balloon, the non-everted membrane or the everted tubular membrane, individually or in combination, covers, surrounds, and/or shields between about 90% and about 100% of the surface area of the balloon.

The sufficient amount of gas, in another embodiment of the present arrangements, causes 100% of the balloon to remain disposed within the launch chamber and the non-extending portion of the inflatable tubular membrane fully shields the balloon. In other words, about 0% of the balloon to be disposed outside of the balloon launching end of the launch chamber.

Balloon 550 has reached a target fill volume, and the inflation nozzle has retracted from the balloon neck. The balloon neck is sealed to retain the lifting gas within balloon 550. An actuation gas supply system regulates pressure in pressurization cavity 522 to maintain upward force on inflatable tubular membrane 504. Retracting mechanism 516 begins to deploy, allowing everting platform 508 and inflated balloon 550 to be raised upward as inflatable tubular membrane 504 begins to evert. The retracting mechanism 516 extends at a controlled rate to regulate the upward velocity and/or acceleration of everting platform 508 and inflated balloon 550.

The present arrangements recognize that, as at least a portion of inflatable tubular membrane 504 everts and extends above the balloon launching end 506, the actuation gas supply system continuously provides gas to the pressurization cavity to maintain the everting pressure. In one embodiment of the present arrangements, the actuation gas supply system includes the balloon securing end of the launch chamber and a linear actuator that moves the balloon securing end up and down within the launch chamber in order to control the pressure in pressurization cavity 522. In other words, movement of the balloon securing end up and down within the launch chamber decreases and increases, respectively, the volume of the pressurization cavity. In this embodiment, pressurization through the displacement of the balloon securing end may be assisted by the addition or venting of gas into and out of pressurization cavity 522.

The everting pressure, in one embodiment of the present arrangements, ranges from between about 1 pascal and about 130 kilopascals. In a preferred embodiment of the present arrangements, the everting pressure ranges from between about 20 pascals and about 10 kilopascals. In a more preferred embodiment of the present arrangements, the everting pressure ranges from between about 100 pascals and about 5 kilopascals.

FIG. 5F shows balloon eversion launching system 500 in the partially everted state, according to another embodiment of the present arrangements. Continued addition and regulation of actuation gas into pressurization cavity 522 forces inflatable tubular membrane 504 to continue everting upward, lifting at least a portion of everting platform 508 and balloon 550 above the balloon launching end of the launch chamber. As balloon 550 extends, everted inflatable tubular membrane 504 fully shields balloon 550 from surface transverse and/or shear winds and other objects proximate to the launch chamber.

FIG. 5G shows balloon eversion launching system 500 in a substantially everted state, according to one embodiment of the present arrangements. Retracting mechanism 516 continues to extend, allowing inflatable tubular membrane 504 to evert further upward. The actuation gas supply system adds an enhanced amount of actuation gas to pressurization cavity 522 to maintain the eversion force. Balloon 550 begins to emerge from the protective enclosure of everted inflatable tubular membrane 504 and becomes exposed to ambient wind conditions. In other words, everted inflatable tubular membrane 504 partially shields balloon 550. The enhanced amount of gas in the substantially everted state, causes the non-everted membrane and/or the everted tubular membrane covers, surrounds, and/or shields between about 1% and about 89% of the surface area of the balloon to partially shield the balloon from transverse and/or shear winds.

A transition between the partially everted state and the substantially everted state may be determined based on when the balloon is fully disposed from the launch chamber. As discussed above, in one embodiment of the present arrangements, the sufficient amount of gas in the partially everted state causes about 0% of the balloon to be disposed outside of the balloon launching end of the launch chamber. The enhanced amount of gas in the substantially everted state causes about 1% to about 100% of the balloon to be disposed outside of the balloon launching end of the launch chamber and the everted portion of the inflatable tubular membrane at least partially shields the balloon.

In another embodiment of the present arrangements, a percentage of inflatable tubular membrane eversion, when balloon is fully disposed from the launch chamber, may be expressed by the following formula:

$$Membrane eversion \% = ( \frac{2 \times {L}_{chamber} - D}{2 \times {L}_{chamber}} ) \times 100 \% ;$$

where L is the length of the launch chamber, between the balloon securing end and a balloon launching end, and D is the balloon diameter.

Thus, the sufficient amount of actuation gas, in one embodiment of the present arrangements, causes between about 5% and about Membrane eversion % of the inflatable tubular membrane to evert and be disposed outside of the balloon launching end. The enhanced amount of actuation, in one embodiment of the present arrangements, causes between about Eversion % +1 and about 100% of the inflatable tubular membrane to evert and be disposed outside of the balloon launching end.

FIG. 5H shows balloon eversion launching system 500 in launched state of the present arrangements. Inflatable tubular membrane 504 has reached a maximum eversion extent, extending substantially above balloon launching end 506. Retracting mechanism 516 has halted extension. A balloon fastener (e.g., balloon fastener 336 of FIG. 3) on everting platform 508 has released balloon 550 before or at the maximum eversion extent. Balloon 550 is released from everting platform 508 and is ejected upward, separating from inflatable tubular membrane 504. Balloon 550 ascends vertically as a free-flying balloon under buoyant lift from the lifting gas contained therein.

FIG. 5I shows balloon eversion launching system 500 in another operative state of the present arrangements. Retracting mechanism 516 retracts everting platform 508 downward toward balloon securing end 505. As everting platform 508 descends, inflatable tubular membrane 504 begins downward inversion, transitioning from its fully everted state back toward its retracted position within launch chamber 502. The volume of pressurization cavity 520 decreases as inflatable tubular membrane 504 inverts and retracts. A gas exhaust port (e.g., gas exhaust port 114 of FIG. 1) removes actuation gas from pressurization cavity 520 to maintain substantially constant pressure as the cavity volume decreases, preventing over-pressurization during the retraction process. The controlled retraction prepares the balloon eversion launching system 500 for the next launch cycle, returning inflatable tubular membrane 504 to its initial positions as shown in FIG. 5A. Once fully retracted, the balloon insertion port door may be opened to allow insertion of a new balloon and payload assembly for subsequent launch operations.

The present teachings offer, among other things, different methods of launching a balloon. FIG. 6 shows a method 600 of launching a balloon according to one embodiment of the present arrangements. Method 600 begins with an element 602 that includes securing, using a balloon fastener (e.g., balloon fastener 336 of FIG. 3), the balloon to an everting platform (e.g., everting platform 308 of FIG. 3). The balloon fastener may be a mechanical clamp, clip, or other restraint mechanism disposed on or adjacent to the everting platform.

Following element 602, element 604 is carried out. Element 604 includes disposing the everting platform, with the balloon secured thereto, within a launch chamber (e.g., launch chamber 102 of FIG. 1). An inflatable tubular membrane (e.g., inflatable tubular membrane 104 of FIG. 1) is disposed within the launch chamber. In one embodiment of the present teachings, the launch chamber includes a balloon securing end (e.g., balloon securing end 105 of FIG. 1), a balloon launching end (e.g., balloon launching end 106 of FIG. 1), and sidewalls (e.g., sidewalls 107 of FIG. 1) that define a launch chamber cavity between the balloon securing end and the balloon launching end.

Next, element 606 includes coupling the everting platform to the inflatable tubular membrane using one or more coupling mechanisms. In one embodiment of the present teachings the inflatable tubular membrane includes a securing ring (e.g., securing ring 442 of FIG. 4A). This coupling element, in one implementation of the present teachings, includes positioning the everting platform below the securing ring, aligning a sealing surface (e.g., sealing surface 430 of FIG. 4) of the everting platform with the securing ring, and engaging one or more coupling mechanisms (e.g., one or more coupling mechanisms 444 of FIG. 4) to latch the everting platform to the securing ring. The coupling creates a pressure-tight seal via a sealing member (e.g., sealing member 446 of FIG. 4A) disposed between the sealing plate and the securing ring, thereby preventing transfer of actuation gas from the pressurization cavity to the launch cavity.

The presence of the inflatable tubular membrane and the everting platform inside the launch chamber divides a space inside the launch chamber and defines a pressurization cavity and a launch cavity. The pressurization cavity is defined between the inflatable tubular membrane, the everting platform, the sidewalls, and the balloon securing end. The launch cavity is defined by the inflatable tubular membrane, the everting platform, and balloon launching end and is configured to house a balloon. When the everting platform is coupled to the inflatable tubular membrane, the balloon is positioned inside the launch cavity of the launch chamber.

Method 600 then proceeds to element 608, which includes dispensing a predetermined volume of lifting gas into the balloon using, for example, a gas diffuser (e.g., gas diffuser 332 of FIG. 3). The gas diffuser is fluidly coupled to a lifting gas reservoir via a lifting gas supply line (e.g., lifting gas supply line 334 of FIG. 3).

Following element 608, element 610 includes sealing the balloon using a sealing mechanism to seal the predetermined volume of lifting gas in the balloon to produce an inflated balloon. The sealing mechanism may include a mechanical clip, tie, or heat seal.

Next, element 612 includes pressurizing the pressurization cavity (e.g., pressurization cavity 222 of FIG. 2) to an everting pressure using an actuation gas supply system (e.g., actuation gas supply system 112 of FIG. 1). As discussed above, the everting pressure causes at least a portion of the inflatable tubular membrane to evert and extend above the balloon launching end to produce an everting tubular membrane. As illustrated in FIGS. 5E, 5F, and 5G, gas is continuously supplied to the pressurization cavity, causing the inflatable tubular membrane to progressively evert upward and extend above the balloon launching end of the launch chamber.

Method further includes element 614, which includes accelerating, using the everting tubular membrane, the inflated balloon and the everting platform toward the balloon launching end with a vertical acceleration. In one embodiment of the present teachings, the acceleration is equal to or greater than the acceleration provided by the lifting gas disposed within the inflated balloon. The acceleration, in another implementation of the present teachings, is controlled by a retracting mechanism (e.g., retracting mechanism 116 of FIG. 1) which extends at a controlled rate to regulate vertical or upward velocity and/or acceleration of the everting platform and the balloon.

In one embodiment of the present teachings, the inflated balloon accelerates towards the balloon launching end at an acceleration rate that ranges from between about 0.1 meters per second squared and about 10 meters per second squared. In a preferred embodiment of the present teachings, the inflated balloon accelerates towards the balloon launching end at an acceleration rate that ranges from between about 1 meter per second squared and about 8 meters per second squared. In a more preferred embodiment of the present teachings, the inflated balloon accelerates towards the balloon launching end at an acceleration rate that ranges from between about 2 meters per second squared and about 6 meters per second squared.

In one embodiment of the present teachings, the inflated balloon moves towards the balloon launching end at a maximum velocity rate that ranges from between about 0.1 meters per second and about 20 meters per second. In a preferred embodiment of the present teachings, the inflated balloon moves towards the balloon launching end at a maximum velocity rate that ranges from between about 0.5 meters per second and about 15 meters per second. In a more preferred embodiment of the present teachings, the inflated balloon moves towards the balloon launching end at a velocity rate that ranges from between about 3 meters per second and about 10 meters per second.

Higher maximum velocities, for example between about ten meters per second and about twenty meters per second, may be achieved in extended-height systems having approximately ten to thirty meters of eversion travel, while maintaining average acceleration within the ranges described above.

In a representative implementation of the present arrangements, the balloon eversion launching system is configured for balloons having a diameter of approximately three meters and a target launch velocity of about four meters per second. Under these conditions, the combination of everting pressure and chamber geometry produces an average vertical acceleration of approximately one meter per second squared over a travel distance of about six to eight meters. These representative parameters fall within the acceleration and velocity ranges described above and illustrate typical operating values for standard-sized balloons.

Smaller launch chambers configured for lighter balloons may produce higher accelerations of up to approximately ten meters per second squared, while larger systems operating at comparable pressures exhibit proportionally lower acceleration consistent with inverse scaling relative to chamber diameter.

Following and/or contemporaneously with element 614, element 616 includes shielding, using the everting tubular membrane, the inflated balloon from cross-winds and ground obstacles. As depicted in FIGS. 5E through 5G, the inflatable tubular membrane surrounds and forms a protective sleeve around the balloon during the eversion process, maintaining the balloon within the protective enclosure until it emerges above the balloon launching end and clears ground-based obstacles. Preferably, shielding occurs contemporaneously with accelerating the balloon.

Next, element 618 includes releasing the inflated balloon from the everting platform. By way of example, the balloon fastener releases the inflated balloon after the inflatable tubular membrane has extended above the balloon launching end. The balloon then ascends as a free-flying balloon under buoyant lift generated by the lifting gas. The inflated balloon, in one implementation of the present teachings, is released from the everting platform at a predetermined distance of the everting platform above the balloon launching end or at a predefined pressure within the pressurization cavity.

Method 600, in one embodiment of the present teachings, includes dispensing gas from the pressurized cavity and retracting, using the retracting mechanism, the everting platform towards the balloon securing end.

In another embodiment of the present arrangements, method 600 includes an optional step of partially pressurizing the pressurization cavity to an initial containment pressure before dispensing the lifting gas. This pre-pressurization causes the inflatable tubular membrane to expand into a launch cavity and surround the uninflated balloon, providing a protective barrier during inflation. The initial containment pressure is less than the everting pressure used in the subsequent eversion element.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly, and in a manner consistent with the scope of the invention, as set forth in the following claims.

What is claimed is:

1. A balloon eversion launching system, the system comprising:
a launch chamber including sidewalls, a balloon securing end, and a balloon launching end and wherein the launch chamber has defined therein an opening capable of receiving an actuation gas that contributes to launch of a balloon;
an everting platform disposed inside the launch chamber in a non-everted state, disposed inside and/or outside the launch chamber in a partially everted state, and disposed outside the launch chamber in a substantially everted state;
an inflatable tubular membrane being coupled and arranged contiguous with the everting platform, being disposed inside the launch chamber and extending from the balloon launching end to the balloon securing end such that presence of the inflatable tubular membrane and the everting platform inside the launch chamber divides a space inside the launch chamber and defines a pressurization cavity and a launch cavity, wherein the pressurization cavity is defined by the sidewalls, the balloon securing end, the everting platform, and the inflatable tubular membrane, wherein the launch cavity is defined by the inflatable tubular membrane, the everting platform, and balloon launching end and is configured to receive and position the balloon for launch of the balloon;
an actuation gas supply subsystem for supplying the actuation gas; and
wherein, in the non-everted state of the everting platform, the pressurization cavity is occupied with no or insufficient amount of the actuation gas to cause eversion of the inflatable tubular membrane and produce a non-everted membrane, which is not capable of ejecting the balloon, and, in the partially everted state of the everting platform, the pressurization cavity is filled with a sufficient amount of the actuation gas to cause a portion of the inflatable tubular membrane to extend outside the balloon launching end such that the inflatable tubular membrane is configured to fully shield the balloon prior to ejection, and in a substantially everted state of the everting platform, the pressurization cavity is filled with an enhanced amount of the actuation gas to cause a substantial portion of the inflatable tubular membrane to extend outside the balloon launching end and wherein the inflatable tubular membrane is configured to partially shield and ultimately eject the balloon.

2. The balloon eversion launching system of claim 1, wherein the insufficient amount of the actuation gas does not produce any eversion of the inflatable tubular membrane and no portion of the inflatable tubular membrane is disposed outside of the balloon launching end.

3. The balloon eversion launching system of claim 1, wherein the sufficient amount of the actuation gas is configured to cause the inflatable tubular membrane to cover between about 90% and about 100% of a surface area of the balloon.

4. The balloon eversion launching system of claim 1, wherein the enhanced amount of the actuation gas is configured to cause the inflatable tubular membrane to cover between about 1% and about 89% of the surface area of the balloon.

5. The balloon eversion launching system of claim 1, wherein in the partially everted state, the extending portion of the inflatable tubular membrane is configured to fully shield the ballon prior to ejection.

6. The balloon eversion launching system of claim 1, wherein in the partially everted state, the sufficient amount of the actuation gas causes a non-extending portion of the inflatable tubular membrane to remain inside the launch chamber such that the non-extending portion of the inflatable tubular membrane and/or the extending portion of the inflatable tubular membrane is configured to fully shield the ballon prior to ejection.

7. The balloon eversion launching system of claim 1, wherein in the substantially everted state, the substantial portion of the inflatable tubular membrane is configured to fully shield the ballon prior to ejection.

8. The balloon eversion launching system of claim 1, wherein in the substantially everted state, the enhanced amount of the actuation gas causes a reduced non-extending portion of the inflatable tubular membrane to remain inside the launch chamber such that the reduced the non-extending portion of the inflatable tubular membrane and/or the substantial portion of the inflatable tubular membrane is configured to partially shield and ultimately eject the balloon.

9. The balloon launching system of claim 1, wherein the launch chamber is cylindrical, and the coupled inflatable tubular membrane is secured to a perimeter that defines a circumference of the balloon launching end.

10. The balloon launching system of claim 1, further comprising a protective layer disposed within the launch cavity and configured to provide a protective barrier between the inflatable tubular membrane and the balloon.

11. The balloon launching system of claim 1, wherein the balloon securing end includes a balloon insertion port configured to allow insertion of the everting platform and balloon into the launch chamber.

12. The balloon launching system of claim 1, wherein the inflatable tubular membrane includes a securing ring that has defined therethrough a securing ring aperture, configured to receive the balloon, and one or more coupling mechanisms for coupling the securing ring to the everting platform and to prevent transfer of the gas from the pressurization cavity to the launch cavity.

13. The balloon launching system of claim 1, wherein the launch chamber includes an exhaust port to exhaust gas from the pressurization cavity.

14. The balloon launching system of claim 1, wherein a retracting mechanism, coupled to the everting platform and the balloon securing end, retracts the everting platform towards the balloon securing end when the everting platform is pushed towards and/or outside the balloon launching end and controls an upward rate of eversion acceleration of the everting platform.

15. The balloon launching system of claim 14, wherein the retracting mechanism inhibits or prevents lateral movement and/or tilt of the everting platform and inflatable tubular membrane.

16. The balloon launching system of claim 1, wherein the balloon launching end is proximate to a roofline.

17. The balloon launching system of claim 1, further including a movable weather cover that covers or is retracted over the balloon launching end.

18. The balloon launching system of claim 1, wherein the everting platform includes a balloon fastener design to fasten and release the balloon from the everting platform.

19. The balloon launching system of claim 1, wherein the inflatable tubular membrane is made of at least one material selected from a group comprising nylon, polyester, polyolefin, fluoropolymer, thermoplastic elastomer, silicone elastomer, polycarbonate, polyetherimide, polyphenylene sulfide, polyether-ether-ketone, ethylene-vinyl acetate, and polyvinyl chloride.

20. The balloon launching system of claim 1, wherein the flexible tubular membrane has a material thickness that ranges from between about 25 micrometers and about 2000 micrometers.

21. The balloon launching system of claim 1, wherein the balloon securing end is moveably coupled to a linear actuator, wherein the linear actuator causes vertical displacement the balloon securing end to increase and/or decrease pressure within the pressurization cavity.

22. A method of launching a balloon, the method comprising:
securing, using a balloon fastener, the balloon to an everting platform;
disposing the everting platform with the balloon secured thereto within a launch chamber having an inflatable tubular membrane disposed therein;
coupling the everting platform to the inflatable tubular membrane such that the balloon is positioned inside a launch cavity disposed within the launch chamber;
dispensing a predetermined volume of lifting gas into the balloon;
sealing, using a sealing mechanism, the balloon to seal the predetermined volume of lifting gas in the balloon to produce an inflated balloon;
pressurizing a pressurization cavity of the launch chamber to an everting pressure, the pressurization cavity being disposed adjacent to the launch cavity, wherein the everting pressure causes at least a portion of the inflatable tubular membrane to evert and extend outside a balloon launching end of the launch chamber to produce an everting tubular membrane;
accelerating, using the everting tubular membrane, the inflated balloon and the everting platform toward the balloon launching end;
shielding, using the everting tubular membrane, the inflated balloon from cross-winds and ground obstacles, wherein at least a portion of the everting tubular membrane surrounds the inflated balloon; and
releasing, using the balloon fastener, the inflated balloon from the everting platform after the inflatable tubular membrane has extended outside the balloon launching end.

23. The method of launching the balloon of claim 22, further comprising:
pre-pressurizing the pressurization cavity to an initial containment pressure before dispensing the lifting gas, wherein at least a portion of the inflatable tubular membrane is proximate to and/or contacting the balloon resulting from the initial containment pressure, and wherein the initial containment pressure is less than the everting pressure.

24. The method of launching the balloon of claim 22, wherein releasing the inflated balloon includes releasing the inflated balloon from the everting platform at a predetermined distance above the balloon launching end or at a predefined pressure within the pressurization cavity.

25. The method of launching the balloon of claim 22, further comprising controlling, using a retracting mechanism, the vertical acceleration of the inflated balloon, wherein the retracting mechanism is coupled to the everting platform and the launch chamber.

26. The method of launching the balloon of claim 25, further comprising venting gas from the pressurization cavity; and retracting, using the retracting mechanism, the everting platform towards an initial position within the launch chamber.

27. The method of launching the balloon of claim 22, wherein coupling the everting platform to the inflatable tubular membrane includes securing the everting platform to a securing ring, wherein the securing ring is coupled to the inflatable tubular membrane.

28. The method of launching the balloon of claim 22, wherein the everting pressure is a pressure that ranges from between about 100 pascals and about 5 kilopascals.

29. The method of launching the balloon of claim 22, wherein accelerating the inflated balloon toward the balloon launching end occurs at an acceleration rate that ranges from between about 0.1 meters per second squared and about 10 meters per second squared.

30. The method of launching the balloon of claim 22, wherein the inflated balloon moves toward the balloon launching end at a maximum velocity that ranges from between about 0.5 meters per second and about 15 meters per second.
